(19) United States
(12) Patent Application Publication
(10) Pub. No.: US 2009/0213078 A1
(43) Pub. Date: Aug. 27, 2009

(54) USER INTERFACE DEVICES AND METHODS WITH ALPHANUMERIC CHARACTER ENLARGEMENT

(75) Inventor: GARY L. CHRISTOPHER, FOX RIVER GROVE, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 12/035,624

(22) Filed: Feb. 22, 2008

(51) Int. Cl. G06F 3/02; G06F 3/041

(52) U.S. Cl. 345/169; 345/173

(57) ABSTRACT

Disclosed are devices and methods for rendering, on a display of a mobile communication device, digits and/or characters that may be more easily perceived by a visually impaired user. The display shows a selected digit or character by itself, taking up a substantial part of the display. In an embodiment, the digit or character may be rendered by the display so as to subtend at least 2 degrees of arc at a predetermined viewing distance. In another embodiment a touch screen may be used for digit or character entry. Depending on the portion of the touch screen that receives contact input from the user, a user can select a particular digit or character for entry. In this manner, the digit values could be presented to a visually impaired user, for example, for an account number for online banking, while retaining privacy.

### FIELD OF THE INVENTION

Disclosed are electronic devices and methods of electronic devices for user input, and more particularly electronic devices and methods of electronic devices for user input, that are configured to render enlarged digits and characters that are more easily perceivable by a visually impaired user.

### BACKGROUND OF THE INVENTION

Mobile communication devices, such as, for example, cellular telephones, are widely used in today's world, providing a variety of communication possibilities. Mobile phones and other mobile communication devices can be used, for example, for voice calls, online banking, and other forms of e-commerce. Mobile communication devices typically include a keypad, a set of soft keys, a display, and audio capability. Their convenient user interfaces foster the development of a wide variety of applications.

The most common application or use of a mobile communication device is the placing of a phone call. A user may sequentially enter the digits that make up the phone number to be dialed. For example, in an online banking or e-commerce application, a user may enter an account number and often a numeric or alphanumeric passcode. Although many user interfaces provide selectable menu items via a display device, a user typically must enter a series of digits.

Typically mobile communication devices, and other portable electronic devices, have displays that can show several lines of text in a space of an inch or two in each direction. For users with poor eyesight, their visual impairment can present an obstacle to using mobile communication devices, since the digits and characters displayed can be quite small, and difficult for a visually impaired user to see, particularly those users with for example, cataracts, implants, macular degeneration, or other vision problems. In particular, placing a phone call can be problematic for a visually impaired user. Their visual impairment may cause a safety concern when there is a need to place an emergency call to 911 or another emergency number. Moreover, e-commerce and online banking present similar usage difficulties. Although speech recognition technology may provide for the visually impaired user a solution to the problem of placing phone calls, the privacy of the number called can be a concern. Furthermore, privacy issues render speech recognition an unacceptable option for e-commerce and online banking applications.

### BRIEF DESCRIPTION OF THE DRAWINGS

FIG. 1 shows according to an embodiment a mobile communication device configured to render enlarged digits that could be more easily perceived by a visually impaired user;

FIG. 2 shows a user input device according to an embodiment, that is a touch screen configured to receive contact input in a region of the touch screen proximal an edge, for example, proximal the left edge of the touch screen to guide a user's touch in selecting a digit;

FIG. 3 shows a touch screen according to another embodiment, configured to receive contact input within a region adjacent the perimeter of the touch screen;

FIG. 4 shows according to an embodiment a touch screen configured to receive contact input that includes a stroke in a predetermined direction across the touch screen that may function as a backspace or delete key;

FIG. 5 shows according to another embodiment a touch screen configured to receive contact input that includes a tap in a central region of the touch screen that may function as a backspace or delete key; and

FIG. 6 shows according to an embodiment a method of an electronic device for rendering enlarged digits and/or characters that may be more easily perceived by a visually impaired user on a display of the device.

### DETAILED DESCRIPTION

It would be beneficial if a display of a mobile communication device were configured to render enlarged digits that could be more easily perceived by a visually impaired user. It would further be beneficial if a user interface of a mobile communication device were capable of presenting digit values to a visually impaired user, for example, for an account number for online banking, while retaining privacy. It would also be beneficial if the arrangement of digits and characters keys on a touch screen were intuitively positioned to assist a visually impaired user in finding keys. It would in addition be beneficial if a user interface configured to render digits that could be more easily perceived by a visually impaired user, were also configured with text-to-speech capability to provide optional confirmation of an entered phone number to be dialed.

Disclosed are devices and methods for rendering, on a display of a mobile communication device, enlarged digits and/or characters that may be more easily perceived by a visually impaired user. The display shows an enlarged selected digit or character by itself, taking up a substantial part of the display. In an embodiment, the enlarged digit or character may be rendered by the display so as to subtend at least 2 degrees of arc at a predetermined viewing distance. In another embodiment, the enlarged rendered digit or character may have a size greater than 50% of the size of the display. In this manner, the digits and/or characters may be rendered by the display in a way more suitable for visually impaired users to see.

In another embodiment a touch screen may have an intuitive arrangement and activation of digit and character keys or selection areas, and selected digits and/or characters may be rendered to take up a substantial part of the display, for example, greater than 50% of the size of the display. Depending on the portion of the touch screen that receives contact input from the user, a user can select a particular digit or character for entry. In this manner, the enlarged digits that were selected could be more easily perceived by a visually impaired user. Accordingly, the enlarged digit values could be presented to a visually impaired user, for example, for an account number for online banking, while retaining privacy.

In still another embodiment, the mobile communication device or other portable electronic device includes a speaker, and the user interface of the device is configured to provide via the speaker an audio confirmation of selection of a single digit, for example, via text-to-speech capability. Moreover, the user interface may be configured to provide audio confirmation of a sequence of selected, entered, or registered digits. In this way, a user may receive an optional confirmation of an entered phone number to be dialed.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

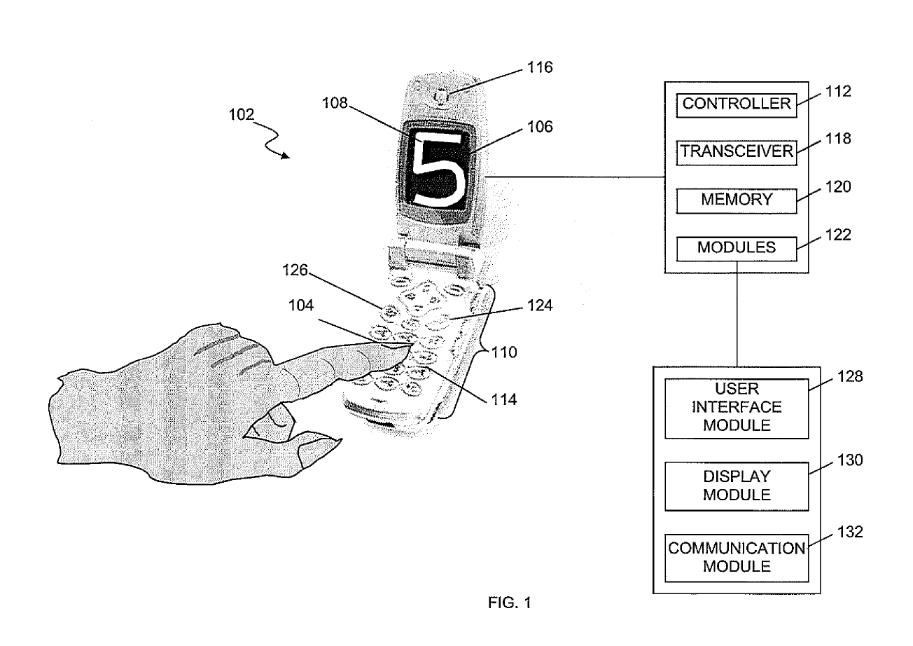

FIG. 1 shows according to an embodiment a mobile communication device 102 configured to render enlarged digits that could be more easily perceived by a visually impaired user. When a user selects 104 a digit or character, the device 102 displays the selected digit or character on a display 106 as an enlarged digit or character 108. The digit or character 108 may be enlarged, for example, so as to subtend approximately 2 degrees of arc or more when viewed by a user at a predetermined viewing distance. The predetermined viewing distance may be, for example, 20 inches. The digit or character 108 may alternatively or in addition be enlarged to a size greater than 50% the size of the display. The percentage of a single digit rendering on a display may vary depending on the size of the display. In this disclosure display of an enlarged digit or character may be referred to as a large format digit or character. In this manner digits and/or characters may be rendered on the display 106 to be more easily perceived by a visually impaired user.

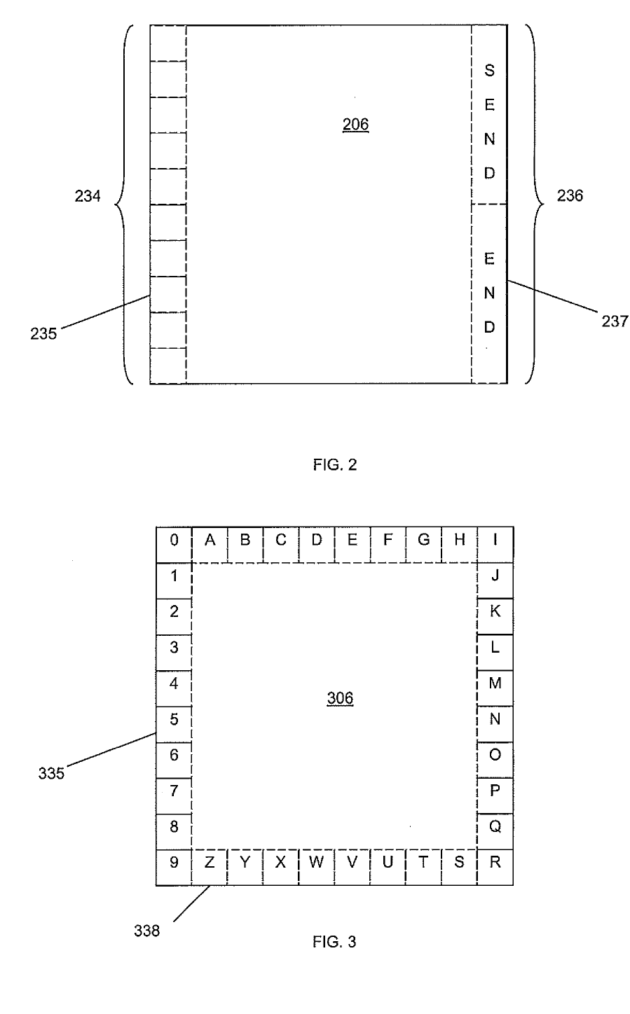

The mobile communication device 102 is shown with a user input device 110 coupled to a controller 112 and that includes a keypad 1 14. In another embodiment the user input device 110 may include a touch screen (206, see FIG. 2) that may be used for digit or character entry. The user input device 110 is configured for tactile input, rather than spoken input. For example, upon receiving input of a single digit, whether from the keypad 114 or from a touch screen, the user input device 110 is configured to generate a single digit selection signal. The single digit selection signal may be processed by the device 102 so that the digit may be rendered on the display 106 as an enlarged digit 108.

As discussed above, selected digits and/or characters may be rendered to take up a substantial part of the display 106, for example, approximately 50% or more of the size of the display. The selected digit values may be entered by a user as part of, for example, an account number or passcode for online banking, where a user may wish to retain privacy. With tactile input rather than spoken input, and a capability to display enlarged digits, the device 102 could receive digit values while retaining privacy.

The mobile communication device 102 may also include a speaker or other audio output device 116 that is coupled to the controller 112 and that may be configured, for example, via text-to-speech capability, to provide an audio confirmation of an entered single digit and/or character. In another embodiment, the device 102 may provide via the speaker 116 audio confirmation of a plurality of single digit selections. That is, after entry of a series of digits making up a telephone number, the speaker 116 may audibly present the entire telephone number to the user for confirmation. In this way, a user may receive an optional confirmation of an entered phone number to be dialed.

While the above discussion is with reference to a mobile communication device 102, it is understood that any type of device that includes a display and is configured to receive user input may be configured to render digits that could be more easily perceived by a visually impaired user, in accordance with this discussion. The mobile communication device 102 may be implemented as a cellular telephone (also called a mobile phone). The mobile communication device 102 represents a wide variety of devices that have been developed for use within various communication networks. Such handheld communication devices include, for example, cellular telephones, messaging devices, personal digital assistants (PDAs), notebook or laptop computers, mobile data terminals, application specific gaming devices, video gaming devices, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The mobile communication device or portable electronic device 102 may include other components such as a transceiver 118, a memory 120, and modules 122. The transceiver 118 may be coupled to the controller 112 and may provide for wireless communication with one or more additional wireless devices via, for example, a cellular telephone network. The memory 120 is coupled to the controller 112 and configured to store instruction modules 122. Moreover, it is understood that some modules 122 may be implemented in hardware, or include hardware components.

The modules 122 include a user interface module 128 coupled to the user input device 110 and to the controller, and configured to receive a single digit selection signal from the user input device. The modules 122 may include a display module 130 coupled to the display and to the controller 112 and configured to render as an enlarged digit a single digit selection output when the user interface module 128 receives a single digit selection signal from the user input device. The modules 122 may in addition include a communication module 132 coupled to the controller 112 and configured to initiate a communication by the transceiver 118 via a send functionality initiated by a send functionality input selection, and configured to terminate a communication by the transceiver via an end functionality terminated by an end functionality input selection.

The modules 122 can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The methods, processes, and operations in accordance with the modules are discussed in more detail below.

As mentioned above, the user interface module 128 is coupled to the user input device 110 and to the controller 112, and configured to receive a single digit selection signal from the user input device 1 10. As an example, the keypad 114 may be a user input device coupled to the user interface module 128 and may provide a single digit selection signal to the user interface module. In another embodiment a touch screen (see FIGS. 2 and 3) may be a user input device coupled to the user interface module 128 and provide a single digit selection signal to the user interface module. It is understood that any tactile user input device, for example a touchpad or navigation circle, is within the scope of this disclosure.

The keypad 114 may include a plurality of keys, with each key of the plurality of keys configured to generate a single digit selection signal. In an embodiment, the keys of the keypad may provide dual functionality for digit selection via a touch and digit registration or entry via key depression. For example, each key of the plurality of keys may be configured to receive touch contact input to select a digit corresponding to the key to generate the single digit selection signal. In certain circumstances, where for example a user is not sure that the key presses are correct, a touch to a key may visually present a digit to the user on the display 106, while the final depression may register the key entry. In an embodiment, each key may have a top surface that may receive touch contact input without requiring depression of the key. The controller 112 may receive the generated single digit selection signal for processing, to generate a single digit selection output for the display 106. Each key may be further configured to register the digit as input when the key is activated by depression. In this way a user may be more certain to input the correct key as entered.

The user interface module 128 may also be configured to provide various additional functionality. For example, the user interface module 128 may be configured to receive a send functionality input selection signal from the user input device 110 and to receive an end functionality input selection signal from the user input device. In an embodiment, for example, a send key 124 and an end key 126 may each have a top surface that may receive contact input without requiring depression of the key. When the top surface of the send key 124 receives contact input, the send key may provide a send functionality selection signal. When the top surface of the end key 126 receives contact input, the end key may provide an end functionality selection signal.

The send functionality and the end functionality coordinate activation of the transceiver 118. As mentioned previously, the transceiver 118 may be configured for communication with, for example, a cellular telephone network. A user may enter a telephone number to be called, and then activate the send functionality of the device 102. The send functionality initiates an interaction of the transceiver 118 with, for example, a server of the cellular telephone network to contact another communication device corresponding to the entered telephone number. The send functionality may be activated by a keypress of the send key 124. At the conclusion of the telephone call the user may terminate contact via the end functionality of the device 102. As with the send functionality, the end functionality may be activated by a keypress of the end key 126. The send key 124 and end key 126 form part of the user input device 1 10. The send key 124 may in addition be activated to register or enter a selected digit and/or character for input.

As previously discussed, a display module 130 may be coupled to the display 106 and to the controller 112, and configured to render as an enlarged digit a single digit selection output when the user interface module 128 receives a single digit selection signal from the user input device. For example, as discussed in connection with the keypad 114, when a top surface of a key of the keypad receives contact input or a touch, the key may provide a single digit selection signal associated with the digit corresponding to that key. The controller 112 may process the single digit selection signal received by the user interface module 128 so that a single digit selection output may be provided to the display module 130 for the user to view the selected digit. The display module 130 may render in a large format the single digit selection output via the display 106, so that the digit may be rendered by the display so as to subtend at least 2 degrees of arc at a predetermined viewing distance. In this manner, the digits may be rendered by the display 106 in a way more suitable for visually impaired users to see.

The display module 130 may be further configured to display a first predominant color to indicate a send functionality upon the user interface module 128 receiving from the user input device 110 a send functionality input selection signal by for example, a touch to the send key 124. The display module 130 may also be configured to display a second predominant color to indicate an end functionality upon the user interface module 128 receiving from the user input device 110 an end functionality input selection signal via a touch to the end key 126. The controller 112 may process the send functionality selection signal received by the user interface module 128 so that send functionality selection output may be provided to the display module 130, so that the display shows a first predominant color in response to the send functionality selection. Correspondingly, the controller 112 may process the end functionality selection signal received by the user interface module 128 so that end functionality selection output may be provided to the display module 130 in a second predominant color, so that the display shows a second predominant color in response to the end functionality selection. In this way a user may know which key has been pressed before registering or entering the key function. It is understood that the display may be configured to show a predominant color in connection with operation of any key of the user interface, and/or to alert a visually impaired user to selection of any functionality of the device 102.

The device 102 accordingly provides a benefit to visually impaired users by rendering on its display 106 digits and characters in a large format so that the digits and characters may be more easily perceived by the visually impaired user. Moreover, the device 102 includes a user input device 110 that may be configured in a more intuitive way to provide visual feedback to the user, whether the user input device is a keypad 114 with key touch/key depression modes or a touch screen (206, see FIG. 2) input device, described below. In addition, user activation of functions of the mobile communication device 102 may be facilitated through rendering of characteristic predominant colors to the display 106 of the device.

FIG. 2 shows a user input device 110 according to an embodiment, that is a touch screen 206 configured to receive contact input in a region 234 of the touch screen proximal an edge, for example, proximal the left edge 235 of the touch screen to guide a user's touch in selecting a digit. The touch screen may be further configured to generate a single digit selection signal corresponding to a single digit when the touch screen receives contact input in a portion of the region 234 corresponding to the single digit. In an embodiment, the regions for digit entry may range from 0 to 9. In another embodiment, the digits may be ordered according to a customary telephone ordering, 1-2-3-4-5-6-7-8-9-0. It is understood that any ordering is within the scope of this discussion. In an embodiment, the arrangement of the touch screen for digit and/or character entry may be configurable to accord better to an individual user's preference or intuition. The controller 112 may receive the generated single digit selection signal for processing, to generate a single digit selection output for the display 106.

As discussed above, it may be beneficial for a user to see which key was activated before actually entering it. This could avoid the need to use a backspace or delete key. Thus, when the user touches the key area, the corresponding digit is displayed but when contact input ceases, the digit may be registered or entered. In this manner the touch screen may be configured to function as a user input device 110 (see FIG. 1) for single digit selecting and registering.

As mentioned, a variety of different touch screen key arrangements are disclosed. The touch screen 206 may in addition be configured to receive touch input in, for example, a region 236 proximal the right edge 237 of the touch screen, in order to receive communication control input, that may be provided via the controller 112 to the display module 130 and the communication module 132. The communication control input may include for example, send functionality input and end functionality input. As discussed above, receipt of the communication control input can result in rendering of a predominant color on the display 106 via the display module 130, and activation of send functionality or end functionality via the communication module 132. Combined with enlarged digit display and color coding for touch and depression, the touch screen can provide confirmation to a visually impaired user of a selection of key choices and function choices.

FIG. 3 shows a touch screen 306 according to another embodiment, configured to receive contact input within a region 338 adjacent the perimeter of the touch screen. The touch screen 306 may be further configured to generate a single digit or single character selection signal when the touch screen receives contact input in a portion of the region 338 corresponding to the single digit or character. Touch regions corresponding to digits may be along a segment of the perimeter proximal a left edge 335. Touch regions for alphabetic characters may be arranged along other segments of the perimeter. It is understood that other arrangements of a touch screen for alphanumeric entry are within the scope of this disclosure. It is further understood that a touch screen may be configured with additional touch regions for, for example, punctuation input. In another embodiment, the touch screen may be configured with send-end functionality as well. In this manner the touch screen may be configured to function as a user input device 110 (see FIG. 1) for selecting and registering selected single digit, single character, punctuation, or send/end functionality.

It is understood that the touch screen of FIGS. 2 and 3 may be configured as the primary display 106 of the device 102, or as a secondary display. As discussed above, selected digits and/or characters may be rendered to take up a substantial part of the display 106 (see FIG. 1), for example, greater than 50% of the size of the display. As discussed above, depending on the portion of the touch screen that receives contact input from a user, the user can select a particular digit or character for entry. In this manner, the digits and/or characters that were selected could be more easily perceived by a visually impaired user. In addition, the digit values could be presented to a visually impaired user, for example, for an account number for online banking, while retaining privacy.

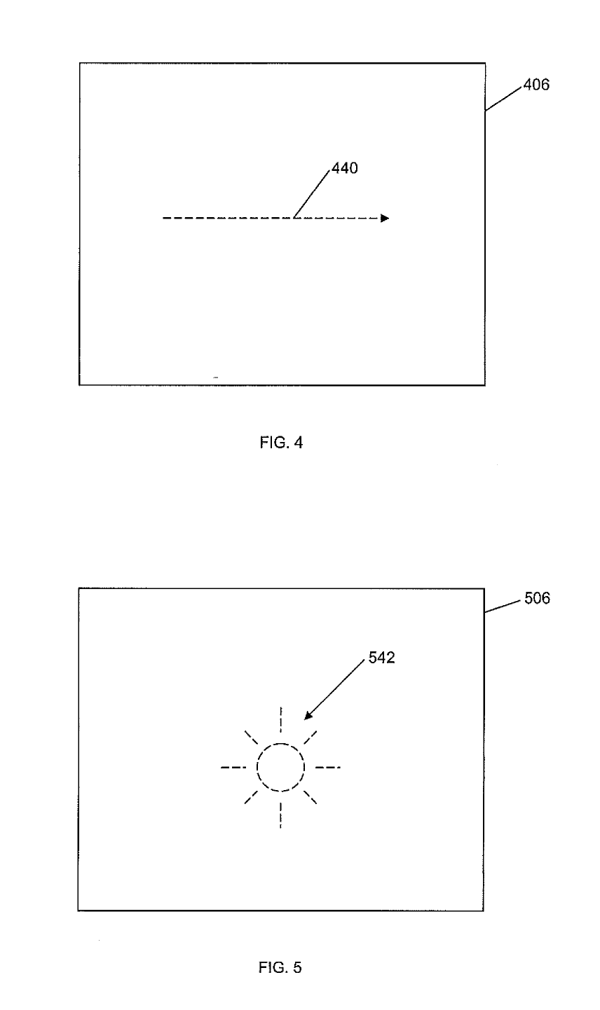

FIG. 4 shows according to an embodiment a touch screen 406 configured to receive contact input that includes a stroke in a predetermined direction across the touch screen that may function as a backspace or delete key. The touch screen may generate a stroke signal upon detecting entry of a stroke in a predetermined direction across the touch screen, to register a delete stroke 440, for example, as shown. The delete stroke 440 may be processed according to instructions of the user interface module 128 configured to delete the last-entered or last registered digit, character, or punctuation input. That is, the touch screen 406 incorporates editing functionality. In this way a user may alter an entered/registered digit and/or character in, for example, a telephone number, an SMS or other message, a password, or a passcode, prior to executing, for example, a “send” functionality.

FIG. 5 shows according to another embodiment a touch screen 506 configured to receive contact input that includes a tap in a central region of the touch screen that may function as a backspace or delete key. The touch screen 506 may generate a tap signal upon detecting entry of a tap in a central region of the touch screen, to register a tap 542 as shown. The tap 542 may be processed according to instructions of the user interface module 128 configured to delete the last-entered or last registered digit, character, or punctuation input. Accordingly, the touch screen 506 incorporates editing functionality. In this way a user may alter an entered/registered digit and/or character in, for example, a telephone number, an SMS or other message, a password, or a passcode, prior to executing, for example, a “send” functionality.

Tap input 542 to the touch screen 506 may be utilized differently according to another embodiment. In the embodiment, a selected digit or character may remain displayed after touch contact input proximal an edge 235 (see FIG. 2) or in a region 338 (see FIG. 3) is broken. Selecting another digit or character via new contact input results in replacement of the displayed digit or character with the newly selected digit or character. The currently displayed digit or character is registered as input upon the user interface module 128 (see FIG. 1) receiving a tap signal generated by detecting entry of a tap in a central region of the touch screen 506. In this manner, the touch screen 506 may be configured to provide for display of selected alphanumeric characters that may be more easily perceived by a visually impaired user, without requiring continuous touch input to the touch screen.

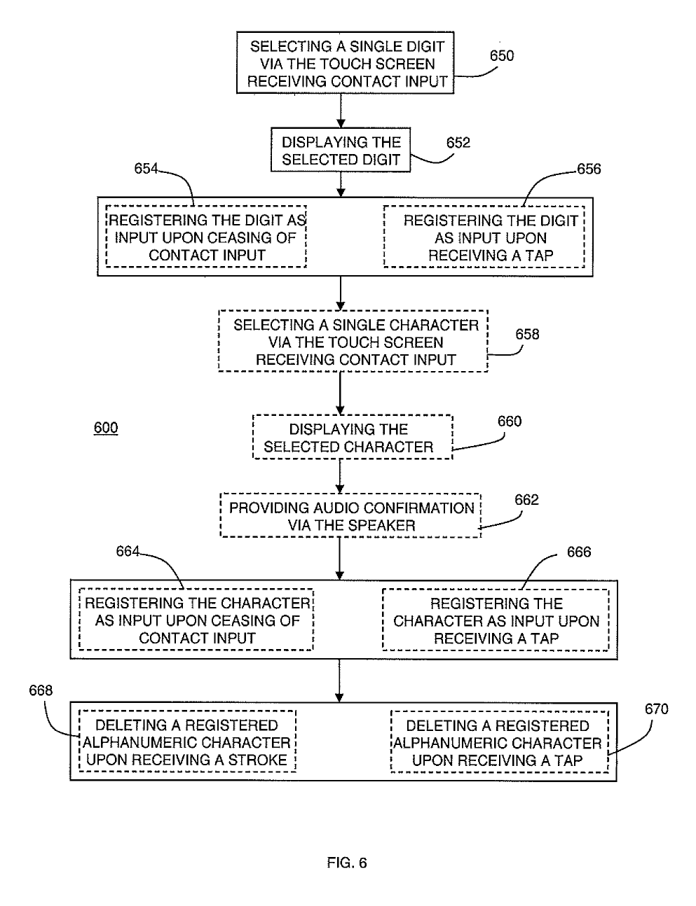

FIG. 6 shows according to an embodiment a method 600 of an electronic device 102 (see FIG. 1) for rendering, on a display 106 of the device, digits and/or characters that may be more easily perceived by a visually impaired user. In the described method, the device 102 may select a single digit upon receipt by the touch screen 206 of contact input in a predetermined region of the touch screen corresponding to the digit. Upon receipt by the touch screen 206 of contact input in the predetermined region of the touch screen, the device 102 generates a single digit selection signal. The single digit selection signal may be processed by the device 102 so that the single digit is rendered on the display 106 in a large format, for example, so that the rendered digit subtends an angle of 2 degrees of arc when viewed from a predetermined distance. In this way, the selected digits may be rendered by the display 106 in a way more suitable for visually impaired users to see.

As mentioned above, the device 102 (see FIG. 1) selects 650 a single digit upon receipt by the touch screen of contact input in a predetermined region of the touch screen corresponding to the single digit to generate a single digit selection signal. The predetermined region may be, for example, near the left edge 235 (see FIG. 2) of the touch screen 206. Upon receipt by the touch screen 206 of contact input, the touch screen generates a single digit selection signal for processing via the controller 112 according to instructions of the user interface module 128.

The controller 112 (see FIG. 1) may process the single digit selection signal to generate a single digit selection output. The single digit selection output may be displayed 652, that is, rendered on the display 106, via the display module 130. As discussed previously, the display module 130 may render the digit so as to subtend, for example, two degrees of arc at a predetermined viewing distance so as to be more easily perceived by a visually impaired user.

In an embodiment, the selected single digit may be registered 654 as input upon the ceasing of contact input to the touch screen 206 (see FIG. 2) during generation of the single digit selection signal. A user may, for example, lift a finger or contact implement from the touch screen 206 upon the user perceiving the desired digit in large format on the display 106 (see FIG. 1). In another embodiment, the selected digit may remain displayed after ceasing of contact input to the touch screen 206, and the selected digit may be registered 656 as input upon the touch screen receiving a tap 542 (see FIG. 5) in a central region of the touch screen. It is understood that the tap may be a finger tap or a tap of a contact implement. In any case, the single digit may be registered as input, in accordance with instructions of the user interface 128.

In another embodiment, the device 102 (see FIG. 1) may select 658 a single alphabetic character upon receipt by the touch screen 306 (see FIG. 3) of contact input in a predetermined region of the touch screen corresponding to the single alphabetic character to generate a single character selection signal. The predetermined region may be, for example, a region 338 (see FIG. 3) near the perimeter of the touch screen 306. Upon receipt by the touch screen 306 of contact input, the touch screen generates a single alphabetic character selection signal for processing via the controller 112 according to instructions of the user interface module 128.

The controller 112 (see FIG. 1) may process the single alphabetic character selection signal to generate a single character selection output. The single character selection output may be displayed 660, that is, rendered on the display 106, via the display module 130. As discussed previously, the display module 130 may render the alphabetic character so as to subtend an angle of, for example, two degrees at a predetermined viewing distance. In another embodiment, the display module 130 may render the alphabetic character to have a predetermined size greater than 50% the size of the display 106. In this manner, the character may be more easily perceived by a visually impaired user.

As discussed above in connection with FIG. 1, the user interface module 128 (see FIG. 1) may be configured to receive input and/or selection signals from the user input device 1 10. In addition, the user interface module 128 may be configured to provide output, via, for example a transducer or speaker 1 16. In an embodiment, the user interface module 128 may be further configured to provide via the speaker 116 an audio confirmation of a single digit selection signal. For example, the device 102 may include text-to-speech capability or a speech synthesizer, with which single digits entered by a user via the user input device 110 may be rendered into speech. The user interface module 128 may also be configured to provide via the speaker 116 a subsequent audio confirmation of a plurality of single digit selection signals. That is, the text-to-speech capability or speech synthesizer may render in sequence a plurality of digits. It is understood that a speech synthesizer may in addition provide audio confirmation of selection of single characters and of selection of a plurality of characters in sequence. It is further understood that audio confirmation of alphanumeric input, that is, selection of a sequence of both digits and alphabetic characters, by a text-to-speech capability or speech synthesizer is within the scope of this discussion. In this way, a user may receive an optional audio confirmation of an entered phone number to be dialed.

The device 102 (see FIG. 1), as just mentioned, may include text-to-speech capability or a speech synthesizer, with which single digits entered by a user via the user input device 110 may be rendered into speech. Accordingly, the user interface module 128 may be configured to provide 662 via the speaker 116 audio confirmation of a single digit selection signal. The user interface module 128 may in addition be configured to provide 662 via the speaker 116 a subsequent audio confirmation of a plurality of single digit selection signals. In this way, a user may receive an optional audio confirmation of an entered phone number to be dialed.

In an embodiment, the selected single alphabetic character may be registered 664 as input upon the ceasing of contact input to the touch screen 306 (see FIG. 3) during generation of the single alphabetic character selection signal. As discussed above, user may, for example, lift a finger or contact implement from the touch screen 306 upon the user perceiving the desired alphabetic character in large format on the display 106 (see FIG. 1). In another embodiment, the selected character may remain displayed after ceasing of contact input to the touch screen 206, and the selected character may be registered 666 as input upon the touch screen receiving a tap 542 (see FIG. 5) in a central region of the touch screen. It is understood that the tap may be a finger tap or a tap of a contact implement. In any case, the single alphabetic character may be registered as input, in accordance with instructions of the user interface 128.

In an embodiment, a user may delete 668 the last-entered or last registered digit or character. As previously discussed, a touch screen 406 (see FIG. 4) may incorporate editing functionality. The touch screen 406 may be configured to generate a stroke signal by detecting entry of a stroke in a predetermined direction across the touch screen to register a delete stroke 440, for example. Accordingly, the user may delete 668 the last-entered or last registered digit, character, or punctuation input upon the touch screen 406 receiving a stroke. In a similar fashion, a user may delete 670 a registered alphanumeric character upon receiving a tap signal generated by detecting entry of a tap 542 (see FIG. 5) in a central region of the touch screen. Whether by stroke input or by tap input, a user may alter for example, an entered/registered digit and/or character in, for example, a telephone number, an SMS or other message, a password, or a passcode, prior to executing, for example, a “send” functionality. In this manner a user may edit telephone numbers, account numbers and/or passcodes, or other alphanumeric entries without the need to find a backspace or delete key.

The above-described devices and methods may enhance the usefulness of a mobile communication device for a visually impaired user. The disclosed devices and methods provide a mobile communication device or other portable electronic device with a display configured to render enlarged digits and alphabetic characters that could be more easily perceived by a visually impaired user. The user interface of the device by the described touch/depress and touch/release embodiments is configured to present digit and alphabetic character values to a visually impaired user, for example, for an account number for online banking, while retaining privacy, and with less possibility of input error and less need for the delete or backspace key. In an embodiment, the user interface is also configured to provide, via a speech synthesizer or text-to-speech capability, optional confirmation of an entered phone number to be dialed. In this manner, the usefulness of portable devices may be enhanced, for users with visual impairment.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

What is claimed is:

1. A mobile communication device, comprising:
a controller;
a display coupled to the controller;
a user input device;
a user interface module coupled to the user input device and to the controller, and configured to receive a single digit selection signal from the user input device; and
a display module coupled to the display and to the controller, and configured to render a single digit selection output when the user interface module receives a single digit selection signal from the user input device;
wherein the single digit selection output is rendered by the display so as to subtend at least 2 degrees of arc at a predetermined viewing distance.

2. The mobile communication device of claim 1, wherein the display has a size, the display module further configured to render a single digit selection output of a predetermined size greater than 50% of the size of the display upon the user interface module receiving a single digit selection signal from the user input device.

3. The mobile communication device of claim 1, further comprising:
a speaker coupled to the controller;
wherein:
the user interface module is further configured to provide via the speaker an audio confirmation of a single digit selection signal; and
the user interface module is further configured to provide via the speaker a subsequent audio confirmation of a plurality of single digit selection signals.

4. The mobile communication device of claim 1, the user input device comprising:
a keypad having a plurality of keys and coupled to the user interface module, each key of the plurality of keys configured to generate a single digit selection signal;
wherein each key of the plurality of keys is configured to receive contact input to select a digit corresponding to the key to generate a single digit selection signal for processing to generate a single digit selection output, and configured to register as input the digit when the key is activated by depression.

5. The mobile communication device of claim 1, wherein:
the user input device comprises a touch screen coupled to the controller and configured to generate a single digit selection signal for processing to generate a single digit selection output, and configured to register as input a single digit;
the touch screen is configured to receive contact input in a region of the touch screen corresponding to a single digit to generate the single digit selection signal for processing to generate the single digit selection output; and
the touch screen is further configured to register as input the single digit when contact input ceases during generation of the single digit selection signal.

6. The mobile communication device of claim 1, wherein:
the controller is configured to provide a plurality of functionalities having associated functionality input selection signals;
the user interface module is further configured to receive a particular functionality input selection signal from the user input device; and
the display module is further configured to display a predominant color to indicate a functionality upon the user interface module receiving from the user input device the particular functionality input selection signal.

7. The mobile communication device of claim 1, further comprising:
a transceiver coupled to the controller; and
a communication module coupled to the controller and configured to initiate a communication by the transceiver via a send functionality initiated by a send functionality input selection, and configured to terminate a communication by the transceiver via an end functionality terminated by an end functionality input selection;
wherein:
the user interface module is further configured to receive a send functionality input selection signal from the user input device and to receive an end functionality input selection signal from the user input device;
the display module is further configured to display a first predominant color to indicate send functionality upon the user interface module receiving from the user input device a send functionality input selection signal; and
the display module is further configured to display a second predominant color to indicate end functionality upon the user interface module receiving from the user input device an end functionality input selection signal.

8. The mobile communication device of claim 7, the user input device comprising:
a touch screen coupled to the controller and configured to generate a send functionality input selection signal when the touch screen receives contact input in a first predetermined location and to generate an end functionality input selection signal when the touch screen receives contact input in a second predetermined location.

9. The mobile communication device of claim 8, wherein:
the touch screen is further configured to register as input a send functionality input selection when contact input ceases during generation of the send functionality input selection signal, and to register as input an end functionality input selection when contact input ceases during generation of the end functionality input selection signal.

10. A method of the mobile communication device of claim 1, wherein the user input device comprises a touch screen coupled to the controller, the method comprising:
selecting a single digit upon receipt by the touch screen of contact input in a predetermined region of the touch screen corresponding to the single digit to generate a single digit selection signal;
displaying the single digit on the display; and
registering as input the single digit upon receiving a tap signal generated by detecting entry of a tap in a central region of the touch screen;
wherein the selected single digit remains displayed until it is registered as input.

11. The method of claim 10, further comprising:
selecting a single alphabetic character upon receipt by the touch screen of contact input in a predetermined region of the touch screen corresponding to the single alphabetic character to generate a single alphabetic character selection signal;
displaying the single alphabetic character on the display; and
registering as input the single alphabetic character upon receiving a tap signal generated by detecting entry of a tap in a central region of the touch screen;
wherein the selected single alphabetic character remains displayed until it is registered as input.

12. An electronic device, comprising:
a controller;
a display coupled to the controller;
a touch screen coupled to the controller and configured to generate a single digit selection signal; and
a user interface module coupled to the controller and configured to receive via the touch screen a single digit selection signal;
wherein:
the display includes the touch screen;
the touch screen is configured to receive contact input in a region of the touch screen corresponding to a single digit to generate a single digit selection signal; and
the touch screen is further configured to register as input a single digit when contact input ceases during generation of the single digit selection signal.

13. The electronic device of claim 12, further comprising:
a display module coupled to the display and to the controller, and configured to render a single digit selection output upon the user interface module receiving a single digit selection signal;
wherein the single digit selection output is rendered by the display so as to subtend at least 2 degrees of arc at a predetermined viewing distance.

14. The electronic device of claim 12, wherein the display has a size, and the display module is further configured to display a single digit of a predetermined size greater than 50% of the size of the display upon the user interface module receiving a single digit selection signal.

15. The electronic device of claim 12, wherein:
the touch screen is further configured to generate an alphabetic character selection signal; and
the user interface is further configured to receive via the touch screen an alphabetic character selection signal.

16. A method of an electronic device having a controller, a display coupled to the controller, and a touch screen coupled to the controller, the method comprising:
selecting a single digit upon receipt by the touch screen of contact input in a predetermined region of the touch screen corresponding to the single digit to generate a single digit selection signal;
displaying the single digit on the display; and
registering as input the single digit upon ceasing of contact input to the touch screen during generation of the single digit selection signal.

17. The method of claim 16, further comprising:
selecting a single alphabetic character upon receipt by the touch screen of contact input in a predetermined region of the touch screen corresponding to the single alphabetic character to generate a single alphabetic character selection signal;
displaying the single alphabetic character on the display; and
registering as input the single alphabetic character upon ceasing of contact input to the touch screen.

18. The method of claim 16, wherein the predetermined region is proximal an edge of the touch screen.

19. The method of claim 16, further comprising:
deleting a registered alphanumeric character upon receiving a stroke signal generated by detecting entry of a stroke in a predetermined direction across the touch screen.

20. The method of claim 16, further comprising:
deleting a registered alphanumeric character upon receiving a tap signal generated by detecting entry of a tap in a central region of the touch screen.
